(19) United States
(12) Patent Application Publication
(10) Pub. No.: US 2009/0131273 A1
(43) Pub. Date: May 21, 2009

(54) Correlating spectral position of chemical species on a substrate with molecular weight, structure and chemical reactivity

(76) Inventor: Aaron Lewis, Jerusalem (IL)

Correspondence Address: William A Blake;Jones Tullar Cooper PC, P O Box 2266 Eads Station, Arlington, VA, 22202, US

(21) Appl. No.: 10/570,602

(22) PCT Filed: Aug. 2, 2004
(86) PCT No.: PCT/US04/22302

§ 371 Date: Nov. 14, 2008

(30) Foreign Application Priority Data
Aug. 3, 2003 (IL) 157,206

(51) Int. Cl. C40B 30/10; C40B 60/14; C40B 60/12; C40B 50/14

(52) U.S. Cl. 506/12; 506/40; 506/39; 506/30

(57) ABSTRACT

A system for directly printing a variety of chemicals, including very large molecules on the substrate, includes a channel of nanometric dimension movable with respect to a substrate on which printing is to occur or a substrate movable with respect to the channel. Precision contact of the end aperture, or tip, of the channel with the surface deposits the chemical on the surface. Precision contact can be made by normal force atomic force microscopy or by other techniques that allow controlled contact or near contact with the surface on which the chemical is to be written with fine precision. Multiple channels with multiple orifices may be provided. The channel is connected to a suitable separation device such as a high performance liquid chromatograph and the chemicals are delivered through a probe orifice onto a substrate. The nanometric scale of the probe allows the chemicals to be printed on the substrate at spacings of from several nanometers to hundreds of micrometers in a fashion correlated with some external signal from a device that signals the ejection of a specific chemical.

### CROSS-REFERENCE TO RELATED APPLICATIONS

This application claims the benefit of Israel Application No. 157,206, filed 3 Aug. 2003, the disclosure of which is hereby incorporated herein by reference.

### BACKGROUND OF THE INVENTION

The present application relates, in general, to a method for chemical writing and printing of different chemical species on a substrate, and to a delivery device such as a probe for delivering the species in a spatially defined way to the substrate. More particularly, the invention relates to a single or multiple channel delivery device for chemical writing and printing of different chemical species through one or more of the device channels to locations spaced apart by distances of as great as several hundred microns to distances of only several nanometers, and to a method of connecting the molecular weight of each of the species in a correlated fashion with the spatial position of the species on the substrate, and wherein this position can be related to the structure and reactivity of the chemical in defined environments.

The deposition and confinement of molecules in nanometric domains is a problem of considerable current interest. It is of particular importance when the molecules are of a biological nature, such as DNA or proteins. The age of genomics and proteomics has triggered the development of the “biochip,” an array of dots, each consisting of a small volume of molecules: in a DNA chip, the dots (or spots) consist of fragments of DNA; in a protein chip, the spots consist of various proteins. The biochip allows researchers to study the interaction of a very large number of molecules at once, on a single platform. This is a crucial requirement for processing the vast amount of information involved with the fields of genomics and proteomics. Reading of the chips is typically done using fluorescent probes.

Protein printing is a problem that has been intensively studied, starting with the work of MacBeath and Schreiber [G. MacBeath, S. Schreiber, Science, 289, 1760 (2000).], that showed that protein microarrays spotted using a conventional arrayer GMS 417 (Affymetrix, Santa Clara, Calif.) could be produced for high throughput screening with spot diameters of between 150-200 microns. This study highlighted the problem of the size of the arrays that would result from conventional techniques of protein printing (dot dimensions are of ˜200 μm).

In an attempt to produce smaller features consisting of proteins, several articles have been published, discussing the use of Scanning Probe Microscopy (SPM) techniques to create dots of proteins on surfaces. They were based on earlier methods for delivering molecules to substrates. One of them, Dip-pen Lithography (DPN), has been pioneered by the group of Chad Mirkin [Piner, R. D.; Zhu, J.; Xu F.; Hong, S.; Mirkin, C. Science, 283, 661 (1999)], and consists of dipping an Atomic Force Microscope (AFM) probe in an “ink,” and delivering molecules from the AFM tip to a solid substrate of interest via capillary transport. The other, “Fountain pen nanochemistry” [A. Lewis, Y. Kheifetz, E. Shambrodt, A. Radko, E. Khatchatryan. Appl. Phys. Lett. 75, 2689 (1999)] is based on the development of cantilevered nanopipettes as AFM sensors, and uses these nanopipettes to flow molecules to the substrate. In this latter work it was shown that such a nanopipette AFM sensor could act to write defined patterns with AFM control. This was demonstrated through the deposition of a chemical etchant, to chemically alter a metal film.

Recently [D. Wilson, R. Martin, S. Hong, M. Golomb, C. Mirkin, D. Kaplan, PNAS, 98, 13660 (2001); K. Lee, S. Park, C. Mirkin, J. Smith, M. Mrksich. Science, 295, 1702 (2002).], DPN was used to print proteins on gold surfaces as had previously been demonstrated with much smaller molecules. In the first example [D. Wilson, R. Martin, S. Hong, M. Golomb, C. Mirkin, D. Kaplan, PNAS, 98, 13660 (2001)] the proteins were chemically modified with thiol groups in order to make a covalent linkage with the gold surfaces. In the second example [K. Lee, S. Park, C. Mirkin, J. Smith, M. Mrksich. Science, 295, 1702 (2002).], the protein was not directly written but a small molecule was deposited first to which the proteins had an affinity and thus could absorb to these regions. A third example [A. Bruckbauer, L. Ying, A. Rothery, D. Zhou, A. Shevchuk, C. Abell, Y. Korchev, D. Klenerman, J. AM. CHEM. Soc. 124, 8810 (2002)] of biomolecule printing did not use standard AFM control but relied on working in a solution environment and used the ionic current between two electrodes, one in a straight pipette and the other in the solution, to allow for a feedback signal based on the ionic current. In this experiment the solution contained in the pipette included solubilized biotinylated DNA that was ejected by the electrochemical current onto a streptavidin coated glass surface.

As noted, previous approaches used a single probe to deliver a single chemical. Writing of multiple chemical species required either multiple probes or multiple excursions of the probe from the area of printing to the reservoir of the chemical species where the pen had to be redipped. In addition, such excursions were not always successful since it was not always possible to clean the probe tip to effectively deliver the chemical of interest in a correlated fashion at a single point. In addition, previous methods have been unable to use conventional substrates for protein spotting as was used by MacBeath and Schrieber [G. MacBeath, S. Schreiber, Science, 289, 1760 (2000).]. This is important since proteins spotted on such substrates are active in terms of their reactivity with other molecules. However, the techniques of MacBeath and Schreiber were not able to go to nanometric dimensions. Furthermore, previous attempts to eject a variety of molecules from small to large proteins from tapered tubes in air with atomic force control were not successful. Finally, previous methods were not able to match, in a correlated fashion, the molecular weight of a chemical with the spatial position of that chemical on the substrate and to relate this to the structure and reactivity of the chemical in defined environments.

### SUMMARY OF THE INVENTION

The current invention is based on the discovery that a variety of chemicals, including very large molecules, can be directly printed onto a surface through a channel of smaller nanometric dimensions when precision contact of such a channel is made with the surface. This precision contact can be done by normal force atomic force microscopy or by a variety of other sensing methods that allow for contact with the surface with fine precision. Such a small channel can work even in an air environment, without the necessity of the surrounding liquids that are required in previously reported electrochemical techniques for the ejection of large molecules [A. Bruckbauer, L. Ying, A. Rothery, D. Zhou, A. Shevchuk, C. Abell, Y. Korchev, D. Klenerman, J. AM. CHEM. Soc. 124, 8810 (2002)].

Thus, in accordance with the present invention, a universal printing system is provided that delivers molecules, even large biomolecules and gases, through nanometric orifices integrally connected to one or more guiding channels in an air or vacuum environment for chemical writing or printing on a substrate. This universal chemical printing device can readily be connected with a variety of separation devices, such as high performance liquid chromographs, or capillary zone electrophoresis devices for depositing selected materials at spatially defined locations on the substrate. Furthermore, the universal chemical printing device can also be connected to analysis instrumentation such as mass spectrometers. In one embodiment of this invention, multiple chemicals, including any intervening cleaning solvents, are delivered through a probe orifice from a guiding channel which is connected to a chemical separation device, such as a chromatograph, in order to write chemically distinct species or structures at correlated positions on a substrate. The guiding channel of this device may also be connected to a combined chromatograph and mass spectral analyzer to enable the measured molecular weight and structure to be correlated with the spatial positioning of specific chemicals. The reactivity of the deposited chemicals can be determined by a variety of techniques, including fluorescence and fluorescence correlation spectroscopy, which is realized in a way that is especially applicable to this invention.

A unique advantage of the system of the present invention is that it allows multiple chemicals to be printed on a single substrate, or chip, through a single channel in a way that correlates the spatial position of the print with a specific chemical. In addition, the spatial position is correlated with the molecular weight or the structure of the deposited chemical, as determined by tools such as mass spectrometers. All of this information is combined with the chemical reactivity of the specific chemical through the use of techniques such as binding assays or the like, and can further be correlated with fluorescence correlation spectroscopy to determine the concentration and dynamics of entities that surround specific chemicals and react with them. This latter technique can be done even at the nano scale of the spacing between written deposits, as described herein. The present system utilizes either far-field optics or uses near-field optics for small illumination volumes at the nanometer scale. The use of near-field optics for measuring the deposited chemicals allows for very high densities of writing on substrates or chips, allowing the method described herein to span with optical techniques from the large areas of far-field optics to the ultra-small areas of near-field optics.

One of the numerous applications of the present invention is the formation of protein chips, wherein a series of proteins are written at spaced locations on a substrate. These deposited proteins are well defined chemically by the methods of the present invention, and their measurements are combined to determine protein cross-reactivity both in terms of conventional assays and in terms of fluorescence correlation assays to give information on the dynamics and concentration of free and bound molecules. Furthermore, the use of near-field optics gives a molecular detection efficiency that is much greater than any other method of illumination for such fluorescence correlation spectroscopy, and the technique of near-field optics results in the advantageous spatial resolutions that are achieved with the present techniques of chemical printing.

Another, non-limiting, application of the invention is the provision of a spatial control of the chemical constituents around molecules that have been printed. This is obtained by the use, for example, of a Self-Assembled Mono layer (SAM) on which a chemical is printed in a spatially defined fashion and the surrounding unreacted regions of the SAM are then reacted with species that have a whole variety of characteristics. These characteristics vary with the charge, hydrophobicity, etc., and the chemical nature, reactivity and structure of the surrounding chemical.

### BRIEF DESCRIPTION OF THE DRAWINGS

The foregoing and additional objects, features and advantages of the invention will become apparent to those of skill in the art from the following detailed description of a preferred embodiment thereof, taken with the accompanying drawings, in which:

FIG. 1 is a diagrammatic representation of a chemical delivery system having a cantilevered delivery device in accordance with the invention;

FIG. 2 is a diagrammatic representation of a near-field optical monitoring system;

FIG. 3 is a diagrammatic representation of the delivery system of FIG. 1, incorporating a straight delivery device; and

FIGS. 4(a) and 4(b) are atomic force images of protein patterns deposited in accordance with the device of FIG. 1.

### DESCRIPTION OF PREFERRED EMBODIMENTS

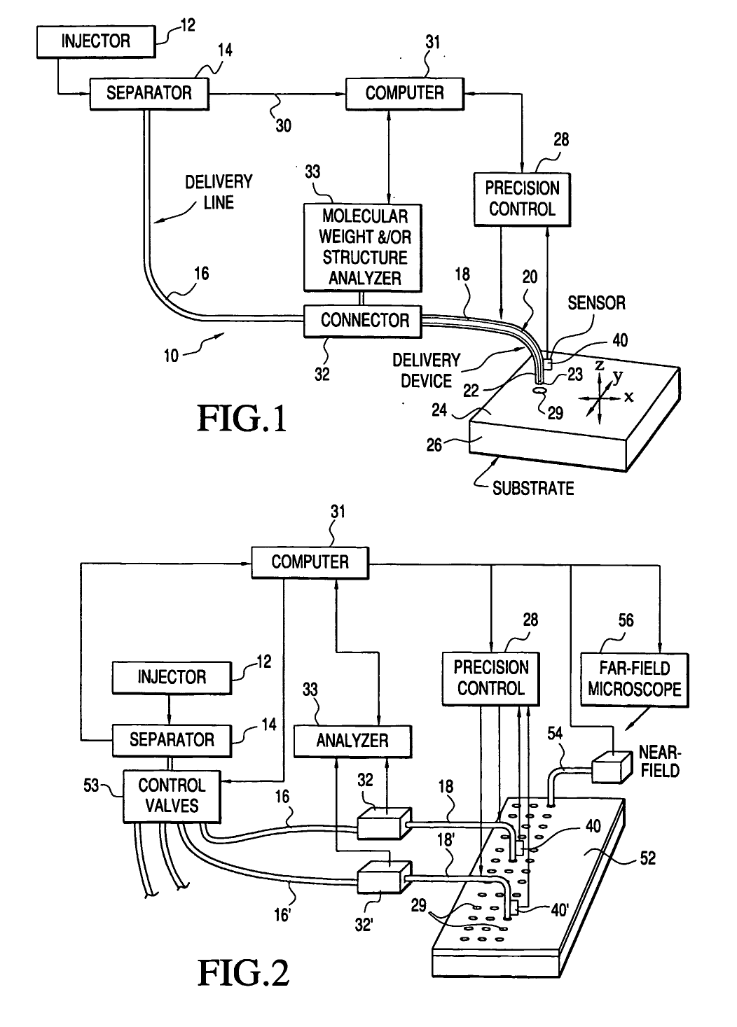

Turning now to a more detailed description of the present invention, FIG. 1 illustrates in diagrammatic form a system 10 for printing multiple chemicals on a substrate. In this system, solutions or mixtures of gaseous chemical species are supplied by an injector 12 or other source, which injects the chemical species into a standard chemical separator 14. The separator may be any standard device for performing chemical separation procedures, and thus may be a high performance liquid chromatograph, may be a device for capillary zone electrophoresis or gas chromatography, or the like. The separator 14 supplies the separated chemicals by way of a supply channel or delivery line 16 to a delivery device 18 which may be a tapered probe having a single internal channel 20 with an apertured tip 22 having an opening 23 at its distal end that may be as small as a few nanometers in diameter. The probe 18, in the embodiment of FIG. 1, preferably is a bent cantilevered probe which is supported above and is movable with respect to a top surface 24 of a substrate 26 by means of a precision controller 28. The controller is capable of moving the probe along X, Y and Z axes with respect to surface 24 in known manner. Although the controller is illustrated as regulating the position of the probe, it will be understood that it may alternatively, or in addition, be used to shift the position of the substrate 26. The chemicals may be deposited on surface 24 when precision contact of the tip 22 of the probe is made with the surface. This precision contact can be carried out by controlling the probe in accordance with normal force atomic force microscopy or by a variety of other control techniques that provide contact with the surface with fine precision to deposit chemicals, as illustrated at spots 29 (FIGS. 1 and 2).

In operation, the separated chemical is delivered to the probe by way of delivery line 16, with the separator 14 producing a signal on line 30 when a chemical is to be ejected and identifying the chemical. This signal may be supplied to the precision controller 28, either directly or through an intervening computer 31 for positioning the probe 18 to deposit the ejected chemical at a spatially defined location on the substrate surface 24. Even large biomolecules can be directly printed through a channel of nanometric dimensions using this device, and the material can be directly printed onto the substrate with precise spacing of as little as several nanometers and as large as hundreds of microns. The computer tracks and correlates the specific chemical and its characteristics that are ejected, and its location on the substrate.

The delivery line 16 can be a flexible glass capillary that is integral with the delivery device, or probe 18, or can be a separate line connected to the probe through a suitable connector 32. If a connector is used, it can also be used to split off a portion of the chemical provided by separator 14 to deliver to an analyzer 33 a sample of the same chemical species that is being supplied to the substrate. The analyzer may be, for example, a mass spectrometer for determining the molecular weight and structure of the chemical species being supplied, and this information is supplied to the computer 31 for correlation with the signal on line 30 and the substrate location information.

If the delivery line 16 is integral with the delivery device 18, it may be a flexible glass tube which is tapered and cantilevered to form the probe; it may be cantilevered from the separator 14 to extend over the surface 24, as illustrated in FIG. 2. Alternatively, the delivery line 16 may be of a material which is generally not flexible, such as silicon, but which may be attached through connector 32 to a flexible or inflexible delivery device 18, or the delivery device may be integral with the delivery line with the end portion being made flexible to form a movable probe. The delivery device, or probe 18, may be connected to a suitable sensor such as a tuning fork for feedback with respect to the surface 24. The delivery device 18 may, in some embodiments, be inflexible, in which case the substrate may be moved with respect to the delivery device.

The delivery device 18 may incorporate a sensor 40 to detect when the tip portion 22 is close to the substrate surface 24. The sensor 40 in FIGS. 1 and 2 is connected or associated with the tip portion or cantilever portion of delivery device 18 to provide an output to the precision control device 28, which provides nanometric control of the delivery device along the X, Y and Z axes with respect to the surface 24 and can be integrated with computer control. The sensor 40 and the controller 28 provide a feedback loop for modulating the specific interaction between the delivery device 18 and the surface 24 to permit a wide variety of chemicals to be deposited on a wide variety of substrates at selected locations spaced apart by nanometers to hundreds of microns. As noted, the substrate or the delivery segment can be moved to print the chemicals in a spatially controlled fashion, and the determination of whether the substrate or the delivering tip is moved depends on the flexibility of the channels used to deliver the chemicals.

The system for chemical printing illustrated in FIG. 1 can be enclosed in a chamber which controls the environment, or can be left in an ambient air environment, depending on the goals of the chemical printing.

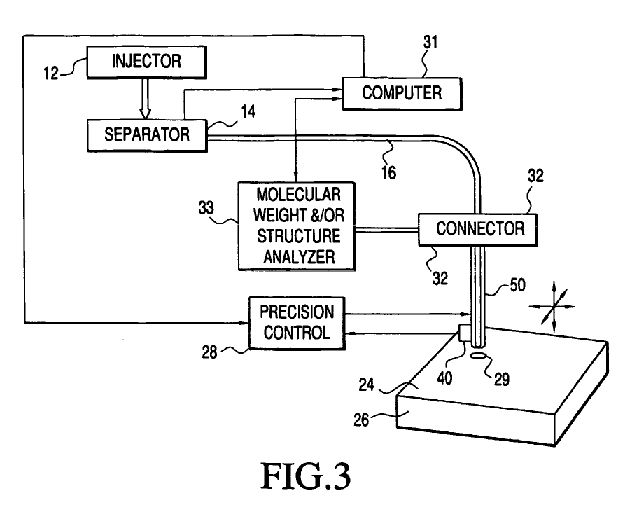

As illustrated in FIG. 3, wherein similar elements are similarly numbered, the curved or bent delivery device, or probe 18, may be replaced by a straight probe or delivery device 50. Although the delivery device 50 is illustrated in this figure as being connected to delivery line 16, it will be understood that the probe can be integral with it, can be connected through a connector 32 to a separate delivery line, or one or both can be connected directly to the separator 14. As discussed above, the probe can be connected in parallel to or in series with the analyzer 33 for molecular weight and structure determination of the chemicals being delivered to the substrate. In this way, the spatial position of the printing is clearly matched to the chemical being separated and can also be clearly related to the molecular weight and structure of a specific chemical at a specific spatial position.

In accordance with the invention, the chemical constituents surrounding the molecules which are printed on the substrate 24 as a part of the foregoing printing process can be controlled. For example, a Self-Assembled Mono layer (SAM) can be deposited on the substrate, as illustrated at 52 in FIG. 2, prior to or after the printing process. When the chemicals are printed in a spatially defined fashion on the SAM layer, as illustrated by dots 29, then the regions surrounding the printed chemicals can be reacted with the chemical species to provide a variety of characteristics that modulate with charge, hydrophobicity, and the chemical nature, reactivity and structure of the surrounding chemical.

Although the invention has been described in terms of a single probe for depositing chemicals or chemical species on a surface, it will be understood that multiple probes may be utilized, as illustrated in FIG. 2 by a second probe 18′ connected through connector 32′ to its corresponding delivery line 16′ which is connected through control valve 53 to the separator 14. The chemical delivery from separator 14 is correlated with the ejection signal to the computer from the separation device, which controls the use of appropriate valves 53 to deposit the chemical at the desired location. Any desired number of probes may be used, with their motion and position regulated by controller 28, and correlated by the computer to the species being deposited, as discussed above. Alternatively, a single probe containing multiple channels may be used connected to one or multiple separation devices with appropriate valves 53 and computer control 31.

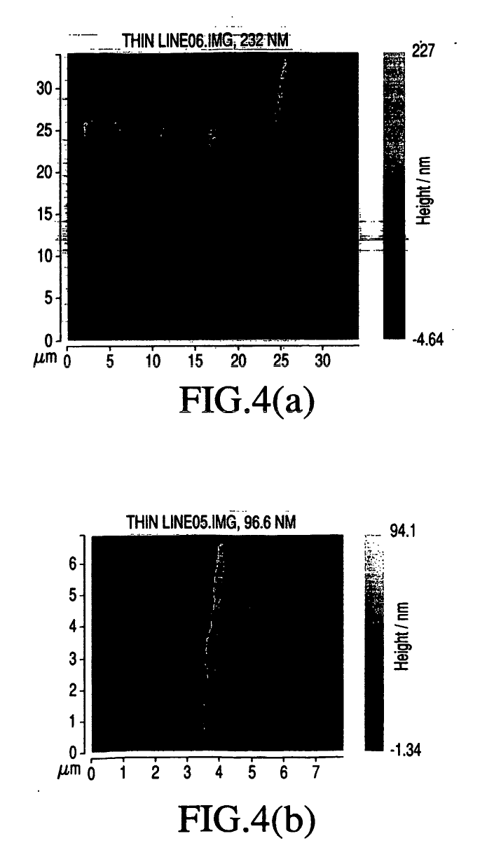

The process of the present invention provides a new understanding of the dynamics, the reactivity and the concentration of molecules in the material surrounding the printed chemicals. This information can now be combined with the chemical reactivity of the specific chemical through standard procedures, such as binding assays, for example, and can also be correlated through fluorescence correlation spectroscopy (FCS) to determine the concentration and dynamics of entities that are surrounding a specific chemical and are to react with it. This determination can be done even at the smallest scales of writing available with the present system through the use of near-field optics, as illustrated by near-field optical probe 54 in FIG. 2. This probe may be used to illuminate the printed chemical species for fluorescence correlation measurements and/or for producing, for example, the atomic force images of the patterns of proteins deposited on the substrate as shown in FIGS. 4(a) and 4(b).

The use of near-field optics as part of the process for detecting and measuring the deposited chemicals allows for very high densities of the deposited species. In addition, it provides a molecular detection efficiency that can be as much as 1,000 times higher than can be obtained through the use of confocal microscopes for FCS detection. However, confocal microscopes such as that illustrated at 56 can also be used to detect the fluorescence of deposited chemicals, and the ability to utilize the optical techniques of both the large areas of far-field optics and the ultra-small areas of near-field optics is an advantage of the invention. Furthermore, this ability is combined, in accordance with the invention, with the ability to provide chemical identification based on molecular weight and molecular structure through the integration of techniques of correlated mass spectral analysis.

It is recognized, as a part of the present invention, that other detection analysis methodologies such as non-linear spectroscopy, especially of the second order type that requires asymmetry, is especially good for detecting with high signal-to-noise ratios the interactions of molecular and other entities with specific regions of a written substrate. Furthermore, it is recognized as a part of this invention that all methods of Raman spectroscopy are important for characterizing the structure and interaction of the chemicals written on substrates such as chips.

Although the present invention has been described in terms of preferred embodiments, it will be apparent to those of skill in the art that variations and modifications may be made without departing from the true spirit and scope thereof, as set forth in the following claims.

What is claimed is:

1. A device that allows the printing of multiple chemicals, including multiple proteins and other large biomolecules, through a single channel, with a pixel size from hundreds of microns to a few nanometers in a fashion correlated with an external signal from a device that signals the ejection of a specific chemical that is to be deposited at a defined spatial position on the surface.

2. A device as in claim 1 that is associated with any means of chemical separation.

3. A device as in claim 2 that can be correlated with a device that could also determine molecular weight either serially or in parallel either before or after the chemical is deposited on the substrate.

4. A device as in claim 2 that can be correlated with a mass spectrometer that can either determine molecular weight and/or structure.

5. A device as in claim 1 that can be associated with multiple such channels each of which can print multiple chemicals either with the channels connected to a chemical separation method directly or through an intervening delivery system.

6. A device as in claim 4 that can be associated with multiple such channels each of which can print multiple chemicals either with the channels connected to a chemical separation method directly or through an intervening delivery system.

7. A device which prints on a substrate a chemical in a controlled fashion as claimed in claim 1 and is then surrounded by other chemicals that can be deposited in a defined way either by using the unreacted groups in a self assembled monolayer around the printed chemical or by some other means of controlling the deposition.

8. A device as in claim 6 that allows for altered chemical properties of the printed chemical by defined chemical surroundings, including but not exclusively by charge, hydrophobicity and other means.

9. A device based on fluorescence correlation spectroscopy to monitor reactivity, dynamics and concentration of other species around the chemicals printed in accordance with claim 1.

10. A device that uses near-field optics for illumination in fluorescence correlation spectroscopy and thus allows for much higher detection efficiencies.

11. A device based on any method of Raman or non-linear spectroscopy to monitor the chemicals printed in claim 1.

12. A device based on fluorescence correlation spectrometry to monitor reactivity, dynamics and concentration of other species around the chemicals printed in accordance with claim 3.

13. A device based on fluorescence correlation spectrometry to monitor reactivity, dynamics and concentration of other species around the chemicals printed in accordance with claim 6.

14. A device in accordance with claim 3 that uses near-field optics for illumination in fluorescence correlation spectrometry and thus allows for much higher detection efficiencies.

15. A device in accordance with claim 6 that uses near-field optics for illumination in fluorescence correlation spectrometry and thus allows for much higher detection efficiencies.

16. A device based on any method of Raman or non-linear spectroscopy to monitor the chemicals printed in accordance with the device of claim 3.

17. A device based on any method of Raman or non-linear spectroscopy to monitor the chemicals printed in accordance with the device of claim 6.

18. A method that allows the printing of multiple chemicals, including multiple proteins and other large biomolecules, through a single channel, with a pixel size from hundreds of microns to a few nanometers in a fashion correlated with some external signal from a device that signals the ejection of a specific chemical that is to be deposited at a defined spatial position on the surface.

19. A method as in claim 18 that is associated with any means of chemical separation.

20. A method as in claim 18 that can be correlated with a device that could also determine molecular weight either serially or in parallel either before or after the chemical is deposited on the substrate.

21. A method as in claim 18 that can be correlated with a mass spectrometer that can either determine molecular weight and/or structure.

22. A method as in claim 21 that can be associated with multiple such channels each of which can print multiple chemicals either with the channels connected to a chemical separation method directly or through an intervening delivery system.

23. A method as in claims 18 that can be associated with multiple such channels each of which can print multiple chemicals either with the channels connected to a chemical separation method directly or through an intervening delivery system.

24. A method which prints on a substrate a chemical in a controlled fashion as claimed in claim 18 and is then surrounded by other chemicals that can be deposited in a defined way either by using the unreacted groups in a self assembled monolayer around the printed chemical or by some other means of controlling the deposition.

25. A method as in claim 23 that allows for altered chemical properties of the printed chemical by defined chemical surroundings including, but not exclusively, the charge, hydrophobicity and other means.

26. A method based on fluorescence correlation spectroscopy to monitor reactivity, dynamics and concentration of other species around the chemicals printed in claim 11.

27. A method that uses near-field optics for illumination in fluorescence correlation spectroscopy and thus allows for much higher detection efficiencies.

28. A device for printing multiple chemicals on a substrate, comprising:
a delivery device having at least one channel leading to an aperture;
said delivery device and said substrate being relatively moveable for positioning the aperture with respect to a surface of the substrate;
a source of chemicals to be deposited on said substrate through said aperture; and
a supply line connecting said source to said delivery device, whereby said delivery device deposits said chemicals with a pixel size from hundreds of microns to a few nanometers in a fashion correlated with some external signal from a device that signals the ejection of a specific chemical that is to be deposited at a defined spatial position on the surface.

29. The device of claim 28, further including an analyzer connected to said source for analyzing the chemicals being deposited.

30. The device of claim 29, wherein said analyzer is a mass spectrometer.

31. The device of claim 28, wherein said delivery device includes multiple channels each leading to a corresponding aperture for depositing multiple chemicals on said surface and the delivery of specific chemicals at specific locations is correlated with a signal associated with the chemical being printed.

32. The device of claim 23, further including a self assembled monolayer on said surface around said deposited chemical locations.

33. The device of claim 23, further including near-field optics for monitoring said deposited chemicals.

34. A method for printing multiple chemicals on a substrate, comprising:
supplying multiple chemicals from a source to a delivery device having a single-channel and an aperture;
positioning the delivery device aperture near a surface to deposit said chemicals on said surface; and
moving the delivery device with respect to the surface as said chemicals are deposited to print the chemicals on the surface in a fashion correlated with some external signal from a device that signals the ejection of a specific chemical that is to be deposited at a defined spatial position on the surface.

35. The method of claim 34, wherein supplying multiple chemicals includes separating the chemicals before depositing.

36. The method of claim 34, further including analyzing the chemicals being deposited.

37. The method of claim 36, further including determining the molecular weights of said chemicals.

38. The method of claim 34, further including surrounding the deposited chemicals with a self assembled monolayer to alter the properties of the deposited chemicals.

39. The method of claim 38, further including monitoring the reactivity, dynamics and concentration of said monolayer.

40. The method of claim 29, further including illuminating said deposited chemicals by near-field optics for fluorescence correlation spectroscopy.
